(19) United States
(12) Patent Application Publication
(10) Pub. No.: US 2009/0228323 A1
(43) Pub. Date: Sep. 10, 2009

(54) Method and system for managing on-line recruiting

(75) Inventor: Varouzhan Ebrahimian, Menlo Park, CA (US)

Correspondence Address: Brian Clarke, 334 E. Oakwood Blvd., Redwood City, CA, 94061, US

(73) Assignee: HiAim, Inc.

(21) Appl. No.: 12/381,305

(22) Filed: Mar. 10, 2009

Related U.S. Application Data
(63) Continuation of application No. 61/068,714, filed on Mar. 10, 2008.

(51) Int. Cl. G06Q 10/00; G06F 3/048

(52) U.S. Cl. 705/9; 705/7; 715/753

(57) ABSTRACT

A method and system for managing an on-line recruitment process is disclosed. The method and system permits a hiring manager to obtain resumes of interested parties, review the resumes, invite candidates back for an on-line interview in a virtual interview room, record the interview, have one or more members of the company review the on-line interview and provide an evaluation of the candidate's suitability for the position and potential further interviews. The candidate can then be invited back for more extensive followup interviews with multiple company members in the virtual interview room, which interviews can be recorded and evaluated later. After the evaluation, in a preferred embodiment, a decision is taken whether to invite the candidate for employment.

### CROSS-REFERENCE TO RELATED APPLICATIONS

This application claims the benefit of U.S. Provisional Application No. 61/068,714 titled METHOD AND SYSTEM FOR MANAGING ON-LINE RECRUITING, filed on Mar. 10, 2008, which is incorporated herein in its entirety for all purposes.

### INCORPORATION BY REFERENCE

All publications and patent applications mentioned in this specification are incorporated herein, in their entirety, by reference to the same extent as if each individual publication or patent application was specifically and individually indicated to be incorporated by reference.

### FIELD OF THE INVENTION

The present invention relates, generally, to increasing the efficiency of recruiting and identifying the suitable employees for a business. More particularly, embodiments of the present invention are directed to utilizing internet technologies alone or in combination with well known technologies and techniques to recruit, interview, review, hire and retain employees within the business enterprise, thereby enhancing the overall efficiency of the recruiting process, and, therefore, the business enterprise.

### BACKGROUND OF THE INVENTION

The goal of recruiting employees never changes, hire the perfect employee. The perfect employee differs from company to company, and even differs from department to department within a company. Hiring the perfect employee is the impossible task, as there is no such being as a perfect employee. A perfect employee has both objective and subjective components. Objectively a perfect employee possesses the requisite educational background, the requisite amount of experience, and has the requisite skill set. Subjectively, the educational background and experience directly apply to the needs of the company, and the perfect employee will fit perfectly within the company culture such that an employee will feel comfortable in the company environment. All of these components lead to a company retaining an employee, an employee remaining at the company and the employee meeting the needs of the company.

Companies spend much money to identify, recruit and hire employees as close to perfect as is practicable. There is an ever growing challenge to tap into the next generation of workers, both professional and nonprofessional. However, companies fail to adequately utilize up-to-date technologies in combination with well known recruiting technologies in order to reach a market place of potential employees who are utilizing new technologies at an exponentially growing pace. See John Cheesman, HR's Struggle With Web 2.0, http://thestandard.com/news/2008/02/15/hrs-struggle-web-2-0. However, despite the large sums of money spent on recruiting, companies typically make hiring decisions on less than adequate information.

A recruiting process may take the following typical path: A candidate is identified in some fashion, referred to herein as sourcing (e.g., CV from HotJobs.com, recruiter, university, temp-agency or the like), and a resume or CV is obtained from the candidate. Somebody at the company reviews the CV, and a decision is taken to conduct a screening interview, typically by phone. This decision is based mostly on a comparison between the objective job requirements and the objective criteria provided in the CV (e.g., education, years of experience, type of experience, previous employers and the like). In any event, all of the information evaluated is in black and white. Next, the screening interview is conducted, typically by one individual and typically by phone. This individual has a conversation with the candidate, allowing this one person to have some personal interaction. This individual has the opportunity to ask questions about the candidate's experience and desires. This individual obtains other not so objective information about a candidate's personality, demeanor and intellectual capabilities. This individual reports back to other individuals within the company; however, much of the real, not so objective information gained through the personal interaction is lost in the reporting process. Out of a 30 or 45 minute screening interview, maybe a few points are reported back with a recommendation on proceeding with further interviews. The company, thus, relies on a synopsis and analysis of this one screening interview to make a decision on committing additional resources (for example candidate travel expenses and employees' time) to perform additional interviews.

In many cases these additional resources are wasted, because the one person's analysis and recommendation really did not meet the expectations of the company as a whole. If the company had more complete information, the candidate may never have been invited back for followup interviews. The next step, the additional interviews, suffers many of the same problems as with one person conducting the screening interview. The additional interviews take place with several individuals conducting sequential, in-person interviews with the candidate. The process results in interviewers asking many of the same questions over and over. Each interviewer will have a different personal interaction with the candidate and will obtain different information based on this interaction. In many cases the group of interviewers get together to discuss their impressions of the candidate, or will fill out survey questions. These discussions, and in particular the survey method lose much this additional information that transpired during the 45 minute interview period each interviewer had with the candidate.

Multiple candidates pass through this inefficient data gathering process and a decision is made on whether and who to hire. The decision is somewhat of a crap shoot based on a suspect data collection process. This inefficient data gathering process leads to hiring people who have the wrong or less than adequate qualifications, who do not fit within the work environment, or both. This person is referred to, generally, as a bad-hire. The cost to the company of a bad-hire include: cost of recruiting (financial and people's time); cost of training; disruption in the work place; direct financial losses resulting from poor decisions by the bad-hire; customer dissatisfaction; and the list goes on.

A few companies have attempted to use technologies to address some of these issues. For example, HireVue, in its patent application 2007/0088601 (Ser. No. 11/400,547), describe automating the screening interview process. The application describes storing a preplanned interview or test in the form of stored written and audio-video recorded interview questions for a particular position. The method describes developing questions to test an applicants' knowledge and to require a timed answer, allegedly to prevent coaching of a candidate during the interview or testing process. A candidate is invited to a web based session in which the pre-recorded written and audio-visual questions are presented to the candidate. The candidate then responds to the questions in writing or in recorded audio-visual as required by the form of question.

The HireVue system does not permit followup questions from the company or any clarification by the applicant, because nobody is present to make the followup questions or provide the clarification. The described method and system attempts to remove the person-to-person interaction of an interview, thereby allegedly increasing the efficiency of the interview process for a company. The result will put applicants under undue stress during the interview, and accordingly will result in less than ideal circumstances under which applicants can communicate their strengths. More importantly, the interviewer does not have the ability to assess the subjective information about a candidate (e.g. demeanor, personality, effective interpersonal interactions, overall intelligence, common sense, and the like), or to ask followup questions. The HireVue system is no better, and possibly worse than the traditional system described above. It really is no better than automated resume data parsing, leaving the company in no better position than just making a decision to perform full-blown interviews based on a candidate's written resume alone. The HireVue system continues to provide an inefficient data collection process providing inadequate information upon which to evaluate the suitableness of applicants' abilities to meet the company's employment needs, and less than adequate basis on which to evaluate how well applicants will fit into the culture of a company and meet the company's subjective requirements.

U.S. Pat. No. 6,618,734, assigned to Spherion Assessment, Inc., describes a method and apparatus to accomplish the same thing as HireVue. The system and method of the '734 patent describe establishing a prequalified list of questions and criteria. The questions and qualifications for a position are prequalified by profiling the questions with so-called “subject-matter experts” (e.g., people with work experience supervising the position being advertised) and then approved by the employer. The qualifications are then put out in on a company or recruitment web site. Applicants interested in the position must hit the web site(s) containing the position listing, and further fill out an on-line application. Filling out the application takes them through the prequalified qualifications and questions, where an assessment algorithm determines the suitability based on preset scoring criteria whether the applicant is suitable to proceed to an in-person assessment interview. Like the HireVue process, this process is resume data parsing, but without the video recorded answers, and leaves the company in no better a position to evaluate a candidate than just reviewing a resume. Like HireVue, this system removes all the personal input at the screening stage, in that the reviewer has no ability to interact with the candidate.

Neither HireVue nor Spherion address inefficiencies that occur during the interview process following the screening process. The standard subsequent interviewing process, as described above and used by both HireVue and Spherion, inadequately collects information on candidates' ability to meet a company's needs. The difficulties in finding the right candidate are well documented, and include (without limitation) redundant questions from interviewers, a poor execution of diligence on the candidate, and not being able to determine if a candidate fits into the culture of the organization.

The present invention, embodiments of which are described in further detail below, provides novel and nonobvious systems and methods to enhance the difficult and expensive task of recruiting qualified employees who have a higher likelihood of remaining a productive employee for a company. While the present invention solves many if not all of the disadvantages and difficulties described above, the invention is not limited to only those embodiments that do solve one or more of the disadvantages and difficulties described above.

### BRIEF DESCRIPTION OF THE DRAWINGS

The novel features of the invention are set forth with particularity in the claims that follow. A better understanding of the features and advantages of the present invention will be obtained by reference to the detailed description below that sets forth illustrative embodiments, in which the principles of the invention are utilized, and the accompanying drawings.

In the drawings:

FIG. 1 depicts complex employment recruiting interactions;

FIG. 2 depicts high level overview of an embodiment of the present invention;

FIG. 3 depicts further details of an embodiment of the present invention;

FIG. 4 depicts further details of the step where an employer reviews a resume submitted for a job;

FIG. 5 depicts details of a virtual interview room in accordance with an embodiment of the present invention;

FIG. 6 depicts additional details of an embodiment of the present invention relating to followup a screening interviews process with a candidate; and

FIG. 7 depicts additional details relating to evaluating followup interviews, in accordance with an embodiment of the present invention.

### BRIEF SUMMARY OF THE INVENTION

The present invention provides a computer implemented method and system for managing an end-to-end on-line employment recruiting process for a company. A preferred embodiment of the method comprises, receiving an electronic resume of a candidate or a link to the resume of the candidate from a source in response to a job description for a position. The resume is reviewed by one or more persons to determine whether to invite the candidate for a screening interview. An electronic invitation is sent to a selected candidate for an on-line video interview in a virtual interview room, which may include one or more suggested times for the interview.

In a preferred embodiment the interview is recorded so others in the company can review the interview. In a further preferred embodiment the virtual interview room comprises: an interviewer side; a candidate side; a virtual white board viewable on the interviewer side and the candidate side; and a notes section viewable only on the interviewer side. In one embodiment, the interviewer can see video and hear audio of the candidate (on the interviewer side) and the candidate can see video and hear audio of the interviewer (on the candidate side). The notes section comprises a first part where a set of pre-existing questions or interview outline is saved, and a second part where the interviewer may create pre-interview questions or notes during said on-line interview. The interview is then evaluated, by one or more evaluators (who may include the original interviewer), to determine whether to invite said selected candidate back for further interviews, or if the interview is a further interview make an offer of employment. In another embodiment, when a candidate is invited back for further interviews, calendars of the interviewers are accessed and checked for available time slots, and time slot options for each interviewer are sent to the candidate for scheduling. Other embodiments allow the interviewer to electronically tag the interview corresponding to the question asked in order to provide relatively easy access by the evaluators to various portions of the interview recording in relations to specific questions or notes taken during the interview. Evaluators whether of a screening interview or of followup interviews can provide rankings of the suitability of a candidate, which rankings can then be compiled. A step may also be provided creating a job description including a video component. In addition the resume received may also include a video component or a link to a video component where the candidate can highlight his qualifications. The inventive methods may be implemented using a Software as a Service (SaaS) server over the internet, on a company local server or through any computer readable media. It will be appreciated that: the interview may be a screening interview, in which case the evaluation process results in a decision to invite the candidate back for further interviews; or the interview may be followup interviews resulting in a decision to make an offer of employment (or not) to the candidate. In either case, the ability to capture the interaction and information from a candidate, share that information with others within the organization and analyzed that information provides an employer a powerful mechanism and method to enhance the recruiting process, a much higher likelihood of avoiding a bad-hire.

### DETAILED DESCRIPTION OF EMBODIMENTS OF THE INVENTION

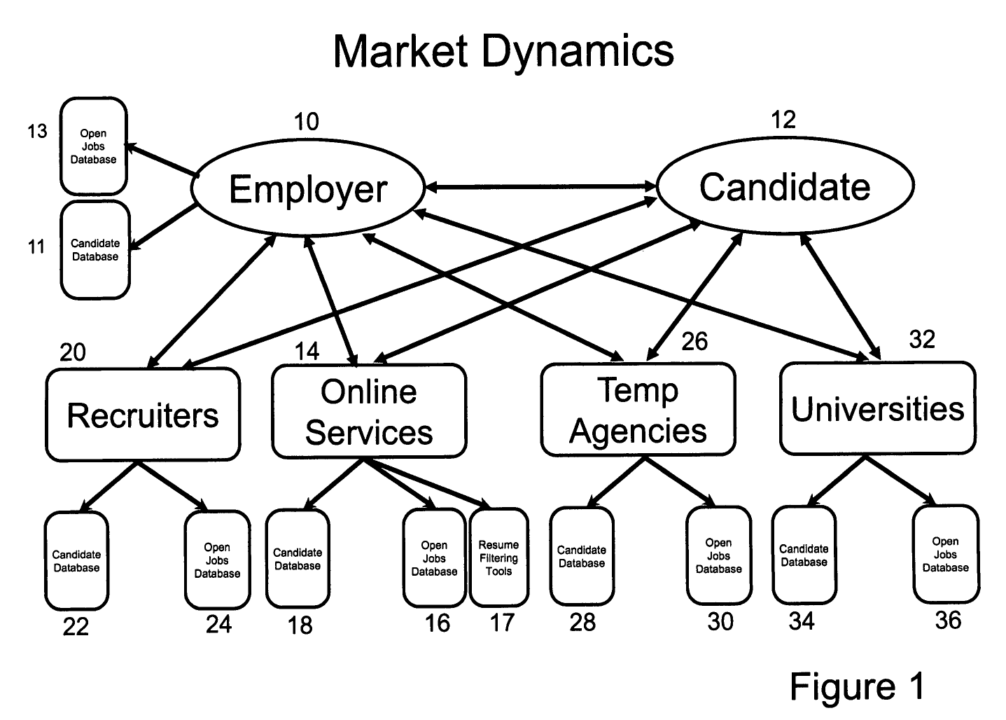

The market dynamics in the field of employee recruitment involve the seemingly simple task of bringing together an employer and one or more candidates. FIG. 1 represents the complex nature of accomplishing this seemingly simple task, which involves multiple players. An employer 10 identifies a need or job, and characterizes the qualifications needed to fill the need. The employer 10, being an organization made up of multiple individuals, also defines a culture, and, thus, defines (although subjectively) the type of person that will fit into the culture. The employer 10 can then wait for a candidate 12 to come and apply to fill the need, or in an effort to reach more candidates the employer advertises the objective criteria with some of the other players in the recruitment marketplace.

On-Line posting services 14, such as HotJobs.com or Monster.com for example, will place the job descriptions on their web sites for a fee charged to the employer. Candidates 12 can search for job descriptions or qualifications in an open jobs database 16, among other things, to find jobs they feel meet the their qualifications and employment desires. It is possible for an employer to attempt to convey some of the culture of the company through these media, but it would only be in words. This mechanism is much akin to advertising job positions in newspaper classified adds, which have been largely outmoded and outdated by the availability of the internet. On-line posting services also serve as resume or candidate database 18 that can be queried by employers in an attempt to identify candidates with qualifications that meet their objective criteria. On-line posting services also provide resume filtering or search tools 17 to help companies identify the candidates with objective qualifications best matching the companies' needs. Employers pay a fee for these services.

Employers 10 can also send the job descriptions to a recruiter 20. The recruiter 20, in an ideal world, has a relationship with the employer 10 and knows, more or less, the culture of the company in addition to qualifications and experience needed to fill a particular job. The recruiter also has, in an ideal world, a relationship with many candidates. A recruiter has a database of candidates' resumes 22 that can be queried for the objective criteria for the job in an open jobs database 24. The recruiter will also maintain a job database 24 that can be queried based on candidates' job search criteria. Based on the personal knowledge of the company culture and the intangibles (e.g. general intellectual abilities and personality) of the objectively qualified candidates, the recruiter can recommend to a company to interview candidates for the position. Recruiters are financially motivated to place candidates, however, and this sometimes shades the judgment of their recommendations.

Similar to recruiters, temporary employment agencies 26 have a group of candidates that can fill particular positions on a temporary basis. They also have searchable candidate resume database 28. Ideally, like the recruiter, the temp agencies have relationships with both the employers and the candidates, and should, theoretically, be positioned to make recommendations to the employer and candidate about good fits between the employer and candidate. Temp agencies 28 also have a database of candidates' resumes 28 that can be queried for the objective criteria for the job, as well as an open jobs database 30 that can be searched for a candidate's job criteria. As with recruiters, temp agencies are motivated to place candidates and this can sometimes shade the judgment of their recommendations. Therefore, the best fit is not always achieved.

Universities 32 are seemingly in a class to themselves amongst the players in the job recruitment world. They do not have personal relationships with either the employer or with the candidate, at least in the same way as a recruiter or temp agency. Moreover, the livelihood of the universities does not rely upon finding employment for the students. In addition, the universities represent a class of people who have virtually no work experience in the field for which they seek employment. Like the other three players, universities have a queriable candidate database 34, and a queriable job database 36, which employers and candidates (respectively) can query for their objective criteria.

The recruiting market is segmented into (without limitation) employers 10, recruiters 20, on-line posting services 14, temp agencies 26 and universities 32. The latter four segments were discussed in some detail above. Employers 10 are further segmented by size, small, medium and large (not shown if FIG. 1). A small enterprise comprises entities that have little or no infrastructure for recruiting, make little or no use of recruiters or outside agencies, post positions on a company career site and possibly on-line job posting services ( e.g., HotJobs.com), and use personal contacts as primary means for recruiting. Medium enterprises typically have a more sophisticated recruitment mechanism. They have on-going relationships with recruiters and agencies, maintain an active career website, have some form of centralized candidate management database 11 and job posting database 13, and postings might not be created on-site, but as part of distributed candidate management systems. Large employers have a large pre-existing infrastructure for recruiting, internal or hosted software applications, a large number of recruiting applications, and utilize a large number of online job posting services.

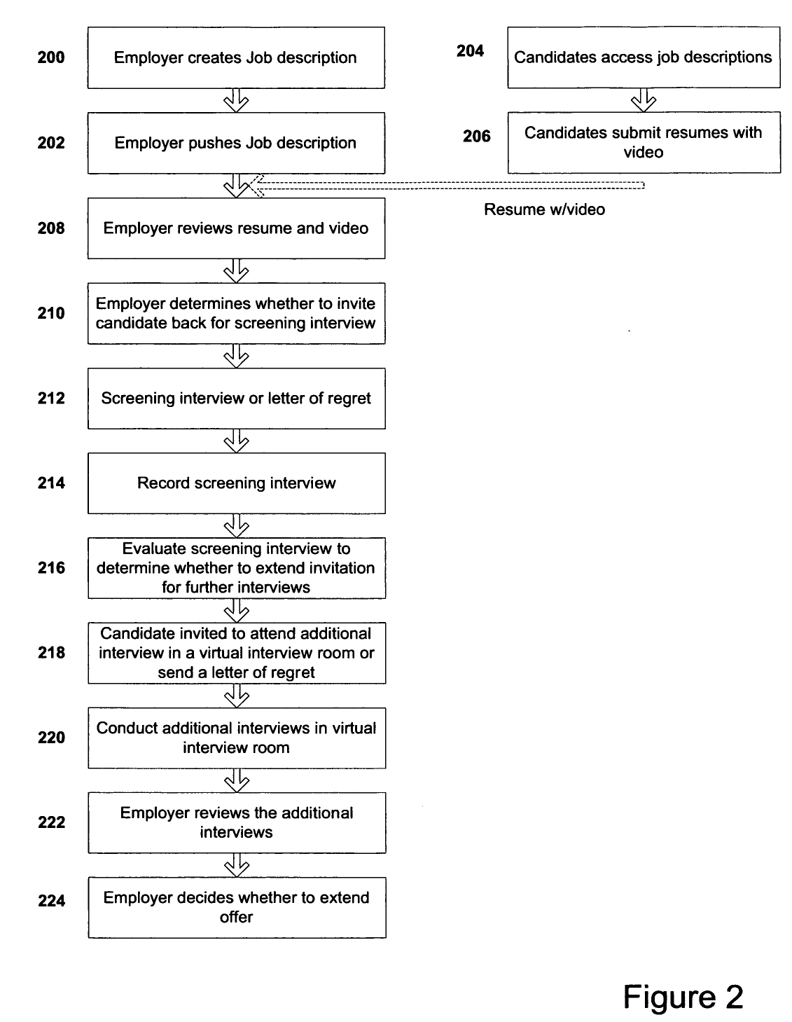

FIG. 2 depicts a high level overview of an embodiment of the present invention. In step 200 an employer creates a job description, and in step 202 pushes the job description to any one or combination of, and without limitation, the company career web site, on-line posting services, recruiters, temporary agencies or universities (also referred to herein as job posting client, or source). In step 204 candidates then access those postings and in step 206 submit resumes, including in one embodiment, as further described below, a video recording summarizing their qualifications. In step 208 the employer then reviews the resumes and video (if available), and in step 210 determines which candidates to invite back for a screening interview. As discussed more thoroughly below, and as distinguished from prior art systems, the screening interview takes place via live on-line video in a virtual interview room. In step 212 the screening interview occurs or a letter of regret is sent. In step 214 the data from this interview is recorded and in step 216 the data is evaluated to make a determination of whether to extend further interviews or send a letter declining further interest. As will be appreciated, the data may include audio and video of the interview, as well as other information apparent to the skilled artisan or as described below. In step 218 the candidate is then invited, via email (preferred) or snail mail, to further interviews with various individuals, again through the virtual interview room or is sent a letter of regret. In step 220 these further interviews are conducted via live on-line video in the virtual interview room, and, as discussed further below, the interview and associated notes are recorded and saved. In step 222 the employer, using the same interviewers and/or additional evaluators within or without the company, review the further recorded interviews. As part of this review, the present invention automates checking references, educational background and other due diligence issues. In step 224 the employer then decides whether to extend an offer of employment or send letter of regret. As described in further detail below, the process may be managed and automated by a SaaS provider, such as that under current development by HiAiM Inc. It is also noted any communication to or from a company or individual may either be by email (preferred), snail mail or other suitable mechanism of transmitting a message (e.g. text messaging, blog or twitter).

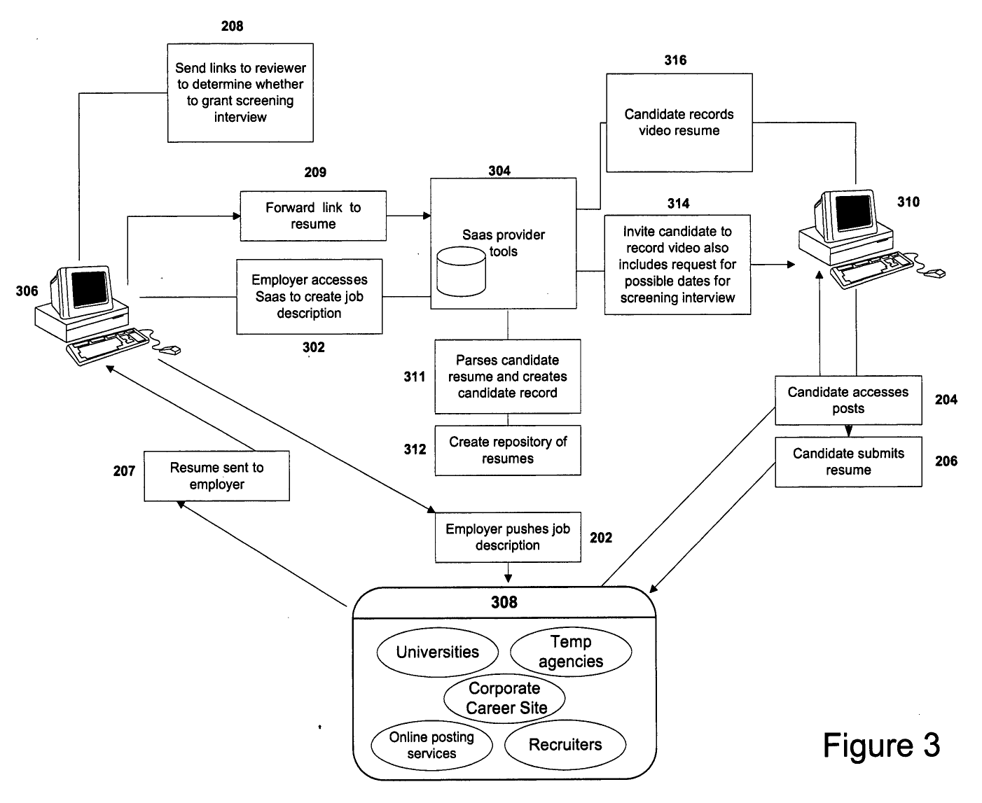

FIG. 3 depicts further details of the step of the employer creating a job description. In accordance with an embodiment of the present invention, in step 302 the employer accesses a software as a service (SaaS) provider 304 (such as HiAiM, Inc.) using an employer client 306, where the employer selects from a pool of existing job description templates, and is provided software tools to create a unique template or to modify an existing template to meet the company's unique needs. Preferably the connection is over a high speed internet connection, but many other suitable means are known to the skilled artisan. Additionally, the SaaS provider 304 may provide the employer with an electronic framework or environment for various company members to collaborate and create appropriate tests and questions to provide during screening or other type interviews. The SaaS provider 304, in accordance with an embodiment of the present invention, may also provide the ability for the supervisor (or other suitable company official) to record a video of the job description, which can be used to accentuate or highlight various aspects about the position. Embodiments of the inventive system also allow for video recording, using webcam, various employees describing, for example and without limitation, the company culture and what they enjoy about working there. Both of these unique video capabilities of the present invention provide the employer an opportunity to reach out to potential applicants in a personal way and to put a positive light on the position and working with the company. Alternatively, the employer can perform step 302 (creating a job description) locally, using tools, and templates residing locally at the employer client 306.

FIG. 3 also depicts further details of step 202 (the employer pushing the job description), including associated video to universities, recruiters, temporary employment agencies, online posting services, and the corporate career link, collectively referenced as 308 (also referred to herein generically and non limiting as job posting services or job posting client or source). It is noted that these services may not have the capability to provide access to the associated job description video. However, in the such an event, a link to the video (or the job description itself) maybe provided on the job posting client to where the video resides, for example at the SaaS provider 304 or some other site such as the corporate career site. Alternatively, the employer could have the SaaS provider, who may manage the career web site for the employer, post the listing at the employer's career link, in addition to pushing the listing out to the other segments 308. It will be appreciated that a link to the job description may be provided as opposed to the job description itself.

FIG. 3 also depicts further details of steps 204 and 206 of the candidate accessing the posted listing and submitting a resume through any one of, but not limited to, the universities, temp agencies, recruiters, on-line job listing services (Monster.com, HotJobs.com) or the corporate career link. All links preferably, though not necessarily, provide the capability to view the video attached to the job listing. Ability to view the video provides a personal touch to sell the position and provides insights to the candidate of the corporate culture. In an embodiment of the method and system according to the present invention the candidate searches for and reviews the job description from his computer or candidate client 310 accessing the universities, on-line job listing services, temp agencies, recruiters or the corporate career link. As noted the recruiters and temp agencies may perform the search themselves and contact the candidate directly, or simply submit the resume to the employer on behalf of the candidate. In step 206, the candidate, either through the recruiter, temp agency, university, on-line listing services or directly through the corporate web link (referred to herein as a source), submits an electronic resume. Thus, in step 207, the source forwards the electronic resume, or a link thereto to the company, which is then forwarded (electronically) in step 209 to the SaaS provider of the present invention. As will be appreciated the company may have the SaaS provider manage the process, in which case the electronic resume (or link thereto) simply would go to the SaaS provider directly. Thus, the employer receives a submitted resume either directly or indirectly (via recruiter, on-line job posting service, temp agency, university, or the SaaS) from the candidate client 310. In step 311, the SaaS provider 304 parses the resume and a candidate record is created. Additionally, the SaaS provider also creates a repository of parsed resumes in step 312 that a different employer may access for a fee. It is noted that, if required or deemed desirable, permission will be sought from the candidate to provide searchable access by other potential employers to a candidate's resume via the SaaS provider's searchable repository. It will be understood, therefore, that the the SaaS provider, in accordance to an embodiment of the present invention, can also serve as a conduit through which an employer can search for potential candidates that meet their objective hiring criteria similar to on-line job posting services.

In step 314 the SaaS provider (or alternatively the employer), in one embodiment, sends an email to the candidate inviting him to record a short video recorded statement about his qualifications for the listed job and any other information he would like to provide. Additionally, may be requested for potential dates for a screening interview should one be granted. It is noted that a skilled artisan will recognize any number of orders in which the steps of the present invention can be performed. In step 316 the candidate may record or provide a link to a video describing his qualifications for the position, and other information he wants to convey to the employer in person, rather than in writing as is traditionally done. This unique aspect of the present invention provides the candidate an opportunity to personally introduce himself to the employer. The video, if provided, may be attached to or associated with the candidate's resume by the SaaS provider 304. In step 316, the candidate may also provide dates he is available for the screening interview, if such an interview is later requested these dates will aid in the scheduling. It is also contemplated that the email to the candidate in step 314 could include an individualized video or a link thereto recorded by the employer to put a more personal touch on the job description, particularly if the job posting client did not provide the video associated with the job posting. The video could be the same video as is associated with the job description described above or different. Moreover, the SaaS provider may provide the tools to personalize the video to particular candidates deemed desirable, which serves as an excellent recruiting tool to target desirable candidates.

Thus, in a general and non-limiting summation to this point, the employer will create a job description on an employer client/computer using local tools or tools provided through the SaaS. The employer may post the job listing using the employer client/computer to various locations (sources) such as on-line job listing services, recruiters, temp agencies, or universities. The candidate, using a candidate client, may search the job listing, and, if interested, submit an electronic resume for consideration either directly or through one of the job posting clients (on-line posting service, recruiters etc, i.e., sources). The resume or a link to the resume may be forwarded from the source to the employer client/computer, which will then forward the link to the SaaS provider. The SaaS provider may parse the resume or obtain the resume from the link and then parse it, and then may send an email to the candidate inviting him to record a video statement to be associated with his resume. This email, in one embodiment, may also request potential dates and times for a screening interview, if such an opportunity should be extended. The email may also include a link to a video by the employer describing the position and the company culture, this video may also be personalized to a candidate. The candidate, using the candidate client, may record the requested video, and provide the requested available dates for a possible screening interview.

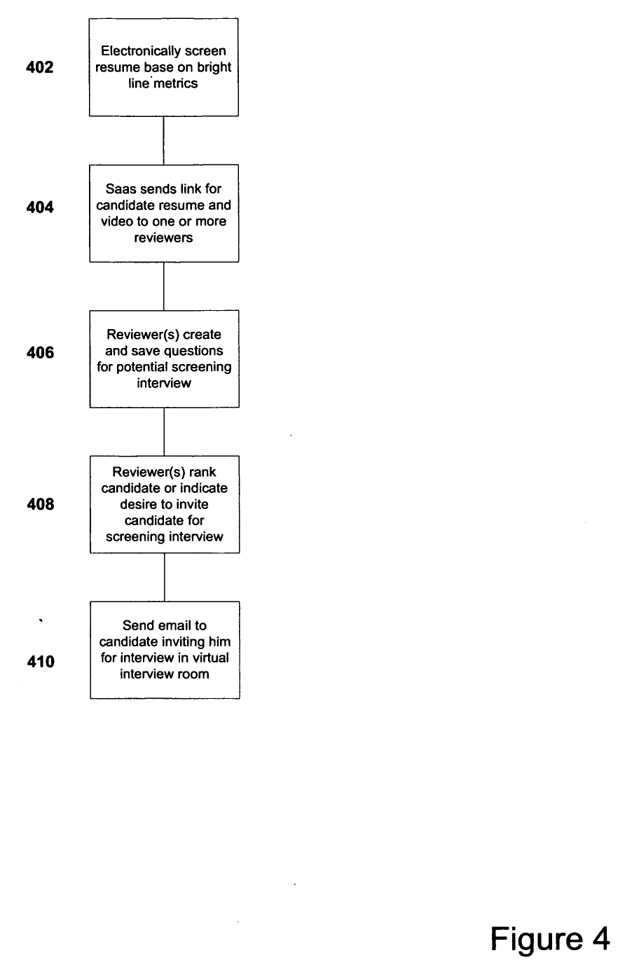

FIG. 4 depicts further details of step 208 of reviewing the candidate's resume. In step 402 the system can electronically screen the submitted resumes based on bright line metrics. These bright line metrics may include, for example and without limitation, requisite educational level and major, professional licenses and the like. Following this screening, if it takes place, in step 404 a link to the candidate's resume and video (if included) is sent to one or more reviewers. Whether one or multiple people reviews the resume and video, this embodiment provides the ability to save mental impressions and comments regarding the candidate. An embodiment also provides step 406, a mechanism by which to create and save questions that may be asked at the screening interview, if one should be conducted. Some or all of these questions can be developed and saved prior to or as part of reviewing resumes, but can either be expanded or created during the interview preparation process. These comments and questions can be saved for future interview preparation in the event the candidate is invited back for a screening interview, or for the purpose of documenting the review for legal purposes. Whether one or more reviewers, in step 408 the reviewers score the candidate on a set scale, or otherwise indicate the desire or level of interest in inviting the candidate back for a screening interview. If multiple reviewers, each reviewer will have access to other reviewers comments, mental impressions and rankings preferably after they have completed their comments and review so as to not bias the reviewer in determining whether to invite a candidate for a screening interview (or make a recommendation of employment if during a follow up interview, as further described below). This will facilitate sharing the reviewers' mental impressions and comments and ultimately facilitate making a decision of whether to invite the candidate for a screening interview or back for further interviews following a screening interview (as described below). It is noted that typically only one person will review the resume and video (if provided) to make a determination whether to invite the candidate for a screening interview. If such a decision is taken, then in step 410 an email is sent to the candidate inviting him back for an interview in a virtual interview room. Preferably, dates/times are provided from which the candidate can select or suggest more convenient times. The email also may contain a link to the interview room. The proposed times may be based on the candidate's previously identified times of availability, if provided. Alternatively, the system can check the schedules of the interviewer(s) and provide a selection of available times to the candidate for the screening interview. Prior to sending the email, the system will verify the schedules of the interviewer or interviewers. Typically, for the screening interview, only one interview session will be conducted, whether by one or multiple interviewers, although it will be appreciated that one or more than one interview session will fall within the scope of the present invention.

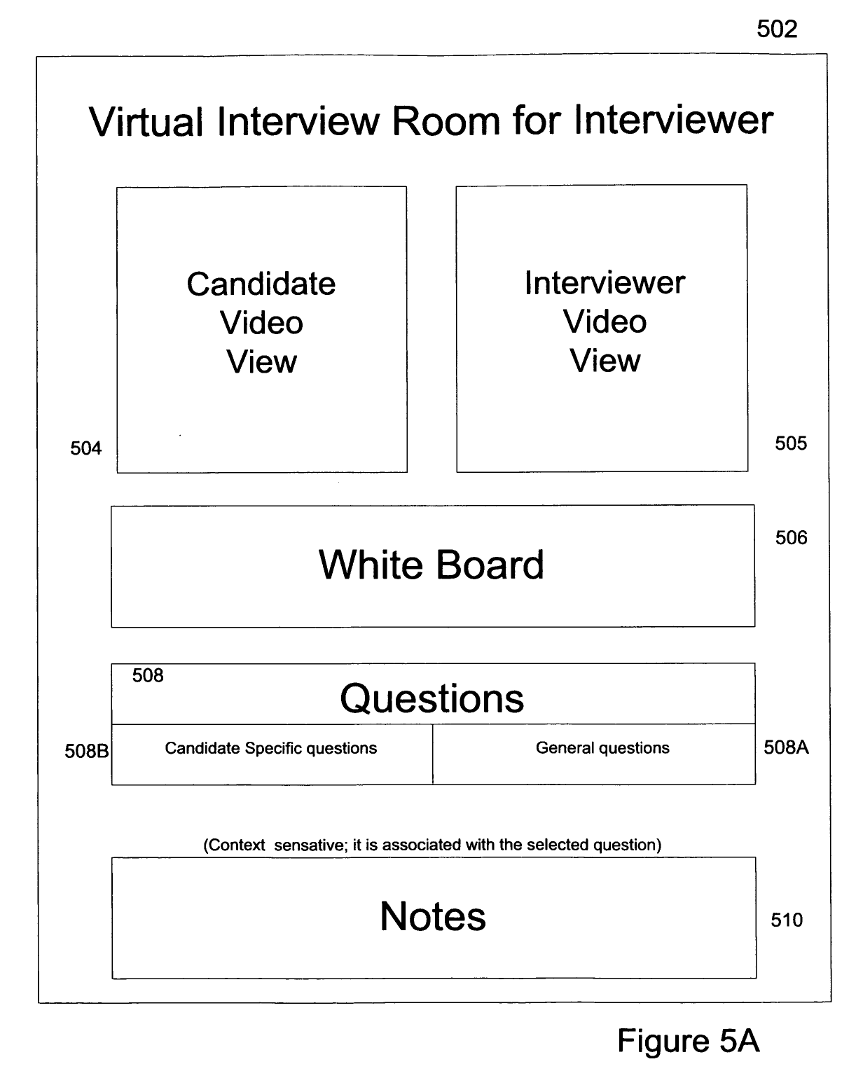

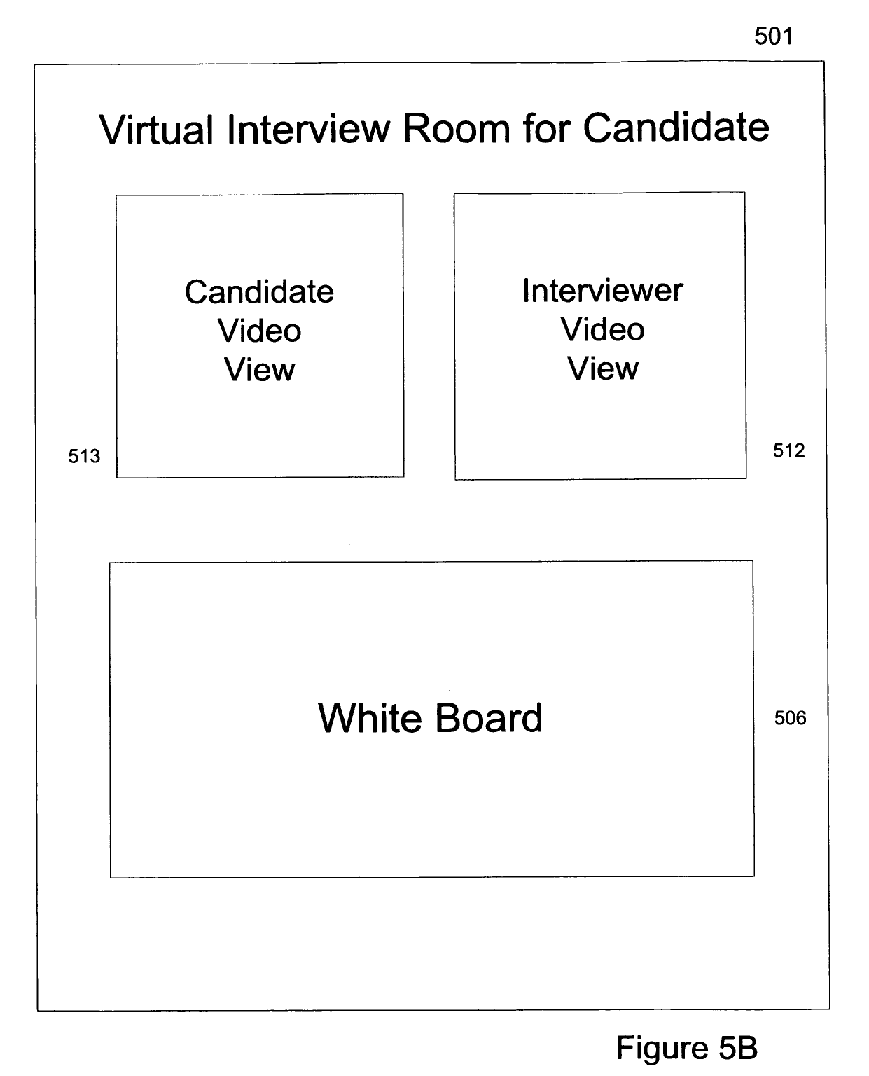

Referring to Figure SA and 5B, the screening interview is conducted on-line in a virtual interview room 500. Virtual interview room has two sides, an interviewer side 502 (FIG. 5A) and a candidate side 501 (FIG. 5B). The interviewer side is broken down into sections. Video section 504 provides live streamed audio and video of the candidate from the candidate client and preferably provides live video of the interviewer 505. As will be appreciated audio may also be done over a phone line, while streaming the video. If more than one person is conducting the interview, additional sections can be provided so the person viewing the video can see and hear the other participants (the candidate and the other interviewers). White board section 506 provides a place, used and viewed by the interviewer and candidate, where demonstrations' or illustrations can be provided in either asking questions or responding to them. One embodiment provides the capability to selectively save the white board, and the relation to the associated question, for future reference either during the interview or for future review of the interview.

Questions section 508 is further broken down into general questions section 508A and candidate specific questions 508B, neither of which is viewable on the candidate side. General questions are questions that have been previously created to ask of every candidate to determine his suitability for the position; these questions can be viewed by all interviewers. Candidate specific questions (if any) are questions created, either during or prior to the interview, specifically for the particular candidate being interviewed and by a particular interviewer. These candidate specific questions are not viewable, in one embodiment, by other interviewers (if any). One embodiment allows the interviewer to electronically tag questions as they are asked to correlate with the video. This permits someone to go straight to that portion of the video relevant to a particular tagged question when reviewing the interview. The candidate specific questions section 508B can also be electronically tagged, which section also includes contemporaneous notes that may have been taken by the interviewer. A separate contemporaneous notes section 510 may also be provided, which can also be tagged, associated with a question, and saved for later reference when reviewing the interview.

In an alternative embodiment of the present invention, if after review of the interview (discussed below) one or more particular questions were deemed effective, those questions can be stored in a database to serve as templates of general questions for use in other interviews for the same or similar positions. This permits HR personnel or senior level company individuals the ability to categorize and-label these questions; in addition, these people can add additional questions from other sources. This database contains an accumulation of questions deemed effective in real interviews, in which an interviewer can search the labels and categories of previously determined effective questions in preparing his general questions prior to the interview. In effect embodiments of the invention “learns” over time to ask more effective questions and to prepare for and conduct more effective. interviews. The database can serve as part of the tools/templates offered by the SaaS provider to aid other clients in developing general questions in the interview preparation process.

FIG. 5B depicts an embodiment of the candidate side 501 of virtual interview room 500. Candidate side 501 has video section 512 providing streamed video of the one or more interviewers, and section 513 providing live video of the candidate. Section 501 provides white board 506, which is shared between the interviewer(s) and the candidate as previously discussed.

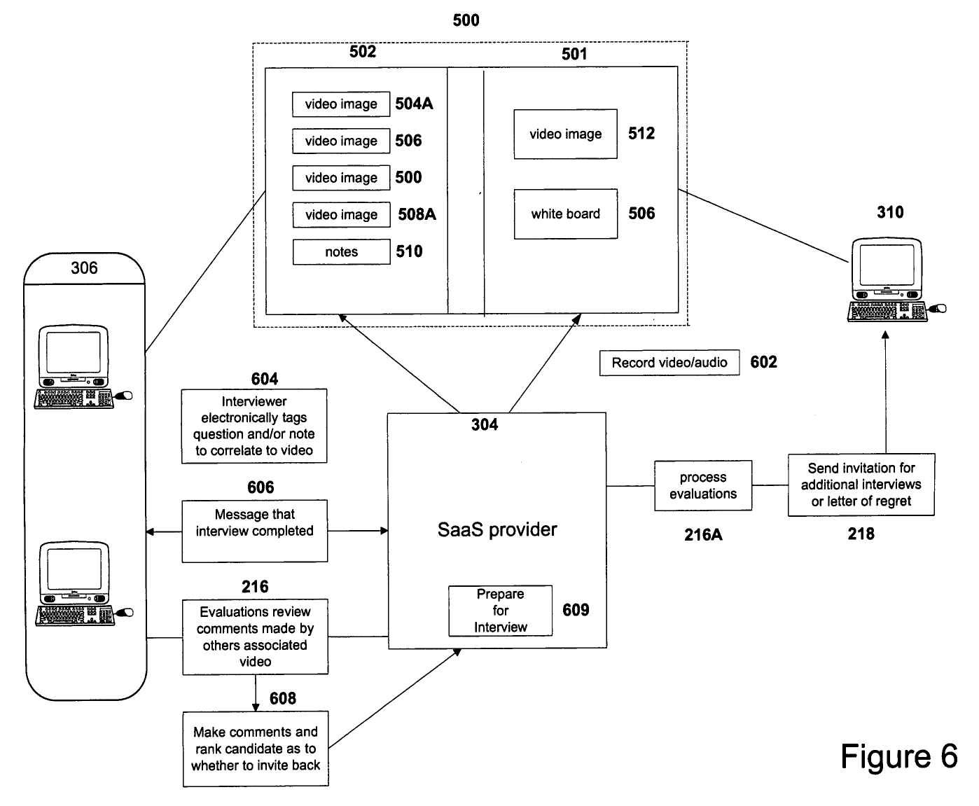

FIG. 6 depicts further details about the screening interview step 212. Prior to the screening interview, the interviewer prepares for the interview in step 609. The interviewer pre-selects from the general questions from the database of general questions for a particular type of position, in addition to adding candidate specific questions. The interviewer(s) asks questions and the candidate responds, as will be appreciated. In step 602 the video and audio are recorded from both the candidate and interviewer sides of the virtual interview room. The interviewer(s) has in front of him the questions for the interview in sections 508A and 508B of the interviewer side 502 of the virtual interview room 500, as well as any specific questions he has created prior to or during the interview. As the interviewer asks the questions, in step 604 he electronically tags the questions to mark the video in relation to that particular question. Tagging the question also serves to remind the interviewer and future interviewers, if any, that the question has been asked to avoid significant redundancy. Redundancy may also be avoided by having the other interviewers, if any, participate in the preparation, or at least review the question prior to the interview. Additionally, in step 604 contemporaneous notes by the interviewer(s) can be made, tagged (if desired) and saved for future reference. It is noted that while video is preferred, the interview can take place in recorded audio, non-recorded audio or saved as a pod cast. It is further noted that the presaved questions may take the form of an outline by which to guide the interview.

FIG. 6 depicts further details about the step 216 of evaluating the screening interview. When each interviewer, if more than one, completes his interview, in step 606 a message is sent to the SaaS provider (HiAiM for example). It is contemplated that interviewers may have access to a previously recorded interview and questions (preferably not contemporaneous notes) in order to prepare for his upcoming interview. In this manner the next interviewer(s), if any, can prepare more targeted, less redundant questions and facilitate getting to know the candidate and his qualifications and personality better. The SaaS provider then sends a message to those interviewers that have completed their interviews that another interview has been completed. A link is provided such that those interviewers that have completed the interview then have access to the comments and interviews conducted by others. The interviewers that have completed the interview have now become evaluators, for the purpose of this description. It may also be the situation where evaluators include people other than those who conducted the interview. In step 216, the evaluators review the comments made by the interviewers and any associated video they feel is necessary to perform the evaluation of whether to invite the candidate back for further interviews following the screening interview. The evaluators have access to all of the data recorded or saved during the screening interview, including but not limited to contemporaneous notes and comments made by the interviewer. The evaluator(s) then make saved comments in step 608 about the candidate based on the screening interview, which comments reflect the evaluators recommendation or judgment about whether to invite the candidate back for further interviews. In one embodiment the evaluator(s) may be asked for a rank as to the desirability of having the candidate back for further interviews. The evaluation is then sent back to the SaaS provider for further processing.

The ability to have more than one individual review the screening interview and the candidate actually answering questions posed during a recorded live interview is quite beneficial to the company. It permits various individuals who did not conduct the live interview, as well as the interviewer, to quickly to jump to answers of specific questions or to review the interview more generally to see and hear how the candidate interacts with the interviewer and the actual unfiltered responses to the questions posed. Embodiments of the invention permit the evaluators to save comments about the candidate for other evaluators to see. A company now has the unique ability to streamline the screening interview process; to have one person conduct the live screening interview, and to have more than one person provide meaningful input on whether to invite the candidate back for further interviews, thereby significantly increasing both the subjective and objective data gathering and analysis process. The concomitant result is reducing the waste of resources during the interview process resulting from inviting unsuitable candidates for the more time intensive and costly follow up interview process. Moreover, it results in inviting back candidates that are not only objectively qualified, but who will be much more likely to fit well into the company organization, and possess other desirable subjective qualifications. Further, it permits the follow up interview to drill down into more worthwhile information beyond the candidate's name, where he went to school, which courses he liked best and for whom he has worked, for example. This upfront better data collection, facilitated by embodiments of the present invention, also permits better data collection during the followup interviews, because it permits the later interviews to focus more on collecting data and information about how the candidate can help the company and how the candidate will fit within the company organization and culture. All of this leads to reducing the risk and associated cost of making a bad-hire, not to mention reducing the cost of the interview process itself.

Continuing reference to FIG. 6, once the SaaS provider receives the evaluation from step 608, it then processes the evaluations in step 216A. This processing step can proceed in a number of different ways, as will be appreciated. In one embodiment, it could average the rankings and depending on a preset algorithm determine whether the candidate had achieved a minimum average ranking to be invited back for additional interviews. Alternatively, the discretion of one evaluator may suffice, or one evaluator may serve to collect the opinions of the other evaluators. It will be appreciated that there are many ways to process the evaluation at this step, many of which will be dependant on the desires of the company.

If it is determined to invite the candidate back for further interviews, the SaaS provider, in one embodiment, obtains the identity and contact information of the additional interviewers. The SaaS provider will obtain and verify the schedules for these people and send an email invitation to the candidate providing potential times for the interviews. One advantage of the present invention is that the interview takes place remotely, and, therefore, it does not need to take place on the same day or even in the same physical location. As is typical in follow up interviews more than one interviewer will meet with the candidate, typically (although not necessarily) in more than one interview session. Thus, the scheduling can be much more flexible with the present invention, with the additional advantage that no travel is necessary. The candidate then selects convenient times for the follow up interviews or proposes modifications. If modifications are suggested, the SaaS provider will then contact the appropriate people or access their calendars to facilitate the scheduling. When scheduling the follow up interviews, it may be more time economical for a person to speak with the candidate directly to get the most convenient schedule, although this is less preferred. When the schedule has been set, the SaaS provider sends invitations to the candidate and the interviewers to attend the scheduled interviews in the virtual interview room. The invitation provides a link to the virtual interview room.

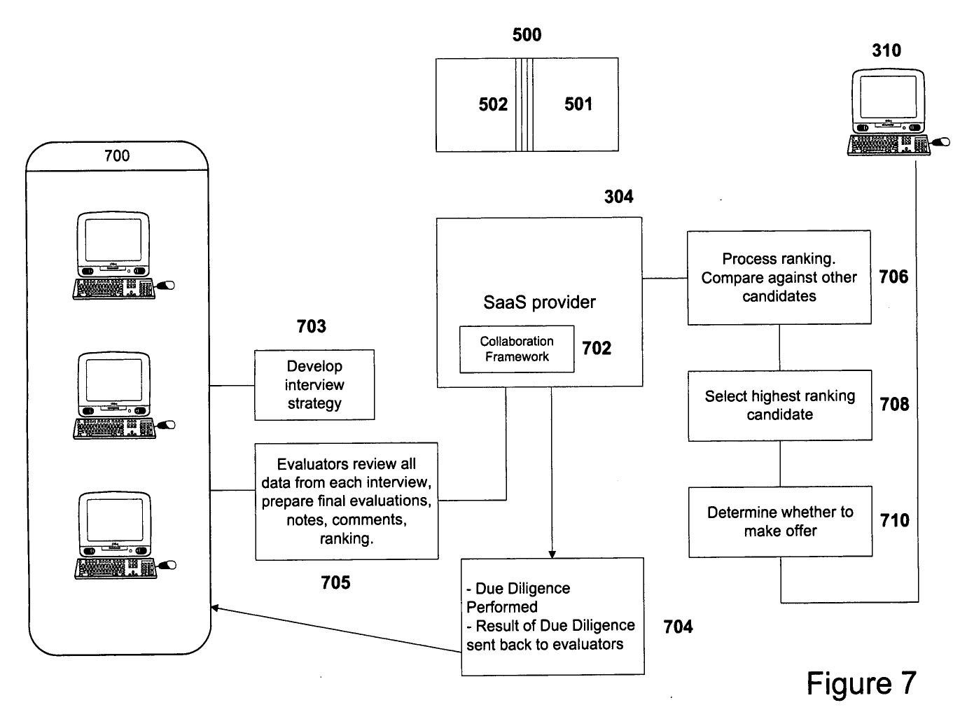

As describe above, the virtual interview room 500 has candidate and interviewer sides. These two sides have all the features described above. Referring to FIG. 7 for the followup interview, the SaaS provider 304 can provide a collaboration framework 702 for use by the followup interviewers 700. This collaboration framework 702 is used in step 703 to develop a strategy for interviewing the candidate and obtaining the best assessment possible as to whether the candidate is a good fit for the position and for the company. The result of the collaboration (in step 703) between followup interviewers, whether using framework or not, is a set of questions or outline topics and strategies. To that end, the objective of the interviewer, before interviewing the candidate, is to learn as much as possible about the candidate and to avoid asking redundant questions. Within this framework, the interviewer can see all the video interactions of the candidate with all the interviewers including the questions that were asked or the questions that are intended to be asked by future interviewers. For questions that were already asked, the candidate can simply select them to quickly access and view the portion of audio/video recording where the candidate answers that specific question. The interviewer will also have access to the resume and/or any other items related to the resume, such as (and without limitation) writings, and drawings, that are relevant to the position. To further guide the interviewing strategy, the interviewer will have access to all the general questions that the company has determined as the most pertinent questions for a particular position and provide a guide to the company interview strategy. This collaborative framework may also be used for conducting the screening interview, if desired. Preferably, interviewers preparing will not be able to view another interviewer's mental impressions until after he has conducted his own interview. The result of the collaboration (in step 703) between followup interviewers, whether using the framework or not, is a set of questions or outline topics and strategies. The questions or topics may be divided amongst the followup interviewers. These common questions are saved, explicitly or in outline form, in the section of the interviewer side of the virtual interview room that is viewable by all the interviewers, general question section 508A. As described above, as an interviewer asks these questions he can electronically tag the questions or outline to mark where in the recorded interview the question was asked or point addressed. Additionally, when an interviewer contemporaneously generates a question during the interview, the interviewer can tag the location in the interview and come back after the interview to add the text that is associate with that question, or alternatively can generate the text during the interview process. As described above, each interviewer is provided a separate place to save (section 508B) individually developed or contemporaneous questions, separate questions or comments that are made prior or during the interview, and the ability to electronically tag these comments to correlate with the videoed interview. The followup interviews take place using the virtual interview room 500 over one or more days.

As each interview is completed, the SaaS provider is notified and, as described above, sends a message and link to the interviewers who have completed the interviews. As described above, the interviewers (now turned evaluators) have the ability and access to evaluate all the data from each interview. The evaluators then prepare their final evaluation notes and comments, including a ranking as to whether the candidate should be extended an offer in step 705.

The SaaS provider will also facilitate the due diligence check on the candidates in step 704. An email will be sent to the candidates' listed references with a set of questions or a link to a web site containing the questions. In responding to the questions at the web site, the reference may respond in recorded audio (using computer microphone), audio-video (using webcam), or in writing. The reference would be given an option to check a box for how he would like to respond to the question, e.g. audio, audio/video, or written. Optionally the reference may call a listed contact to provide the desired answers. The SaaS provider may coordinate the verification of pervious employment, educational back ground and listed authorship citations, e.g., through web services integration. The employer will be sent the results of the due diligence to determine if anything would prevent the employer from extending an offer to any of the candidates. Additionally, the responses from the references may increase or decrease the rankings given by the evaluators, so those people may also be provided this information as part of the evaluation process, either before or after the evaluator provides the ranking and comments; if after, the evaluator is given the opportunity to adjust the evaluation ranking. In another embodiment, the employer directly receives the responses from the references. The skilled artisan will appreciate that there are many ways of performing the reference check that fall within the scope of the present invention.

In step 706 the SaaS provider processes the rankings and comments from all the interviewers/evaluators for all the candidates that were extended additional interviews. In step 708 rankings and comments are compared against each other to determine the best candidate for the position, which can be performed by a computer, an individual (company or SaaS) or a combination of both. In step 710, the best ranked candidate(s) is then compared, either by the SaaS provider or the employer, against a minimum set of qualifications. If the candidate meets the minimum standards, an offer of employment is extended. If not, a letter or email expressing no further action will be taken on the candidate's application at that particular time. For those candidates not ranking as the best qualified, presuming the best qualified candidate was offered and accepted the position, the SaaS provider sends a message indicating that no further action will be taken on their application.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” includes, without limitation, any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal, as well as a propagated machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. Other embodiments may be within the scope of the following claims.

A number of implementations of the disclosure have been described. Nevertheless, it will be understood that various modifications may be made without departing from the scope of the disclosure including the claims.

What is claimed is:

1. A computer implemented method for managing an on-line employment recruiting process for a company, the method comprising the steps: receiving an electronic resume of a candidate or a link to said resume of said candidate from a source in response to a job description for a position; reviewing said resume; sending an electronic invitation, based on said reviewing step, to a selected candidate for an on-line video interview; providing a virtual interview room for conducting said on-line video interview between said selected candidate and an interviewer; generating a recording of said on-line interview, wherein said interviewer may make an electronic tag of said recording for later reference to and evaluation of said on-line interview; providing a collaboration framework for developing a strategy for interviewing a selected candidate; evaluating, by one or more evaluators, said on-line interview to provide an evaluation of said candidate.

2. The method according to claim 1, wherein said virtual interview room comprises: an interviewer side; a candidate side; a question section viewable on the interviewer side; and a virtual white board viewable on the interviewer side and the candidate side.

3. The method according to claim 2, wherein said question section comprises a first part where a set of general questions or interview outline is saved, and a second part where interviewer specific questions are saved, and wherein said collaboration framework is used by a to-be-interviewer to develop interviewer specific questions.

4. The method according to claim 1, wherein said electronic invitation includes a link to a candidate specific account, wherein said candidate specific account requests said selected candidate to provide candidate free/busy information, and wherein said sending step further comprises utilizing interviewer free/busy information to schedule said on-line interview with said selected candidate

5. The method according to claim 1, wherein said electronic tag associates text of the question with a location within said recording.

6. The method according to claim 6, wherein text associated with said electronic tag can be added or changed after said on-line interview.

7. The method according to claim 1, wherein the evaluating step comprises:
sending to said one or more evaluators a link to the recording of the on-line interview;
receiving rankings of said selected candidate from said one or more evaluators;
compiling said rankings; and
making a decision based on said rankings on how to proceed with said selected candidate.

8. The method according to claim 8, wherein said on-line interview is a screening interview, and said decision is whether to invite said candidate back for followup interviews in said virtual interview room.

9. The method according to claim 8, wherein said on-line interview is one or more followup interviews, and said decision is whether to extend an offer of employment to said candidate.

10. The method according to claim 1, wherein said reviewing step further comprises: sending said resume or said link to said resume to one or more company persons, wherein said one or more company persons create one or more comments whether said candidate may meet the job description;
receiving back from said one or more company persons said one or more comments on whether to invite said candidate for said on-line video interview;
producing a ranking of said candidate from said one or more comments; and
making a decision to invite said candidate for a screening interview.

11. The method according to claim 1 further comprising the step of:
creating said job description, wherein said job description comprises a request for a video presentation from said candidate; and
pushing said job description to said source.

12. The method according to claim 11, wherein said job description comprises an audio-video recording or a link to an audio-video recording, wherein said audio-video recording provides information about said position or said company.

13. The method according to claim 11, wherein the creating step further comprises: providing templates of job descriptions.

14. The method according to claim 1, wherein said one or more evaluators is said interviewer.

15. The method according to claim 1, wherein said source is selected from the group consisting of on-line job posting services, recruiters, universities, temporary employment agencies, a career site of said company.

16. The method according to claim 1, wherein said collaboration framework comprises: access to a set of general questions, wherein said set of general questions is created to guide implementation of company interviewing strategies; access to said electronic resume of said selected candidate and all other documentation provided by said selected candidate; and access to questions or an outline of questions that will be asked of said selected candidate.

17. A software as a service (SaaS) web server for executing a method for managing an on-line employment recruiting process, the method comprising the steps:
receiving an electronic resume of a candidate or a link to said resume of said candidate from a source in response to a job description for a position;
reviewing said resume;
sending an electronic invitation, based on said reviewing step, to a selected candidate for an on-line video interview;
providing a virtual interview room for conducting said on-line video interview between said selected candidate and an interviewer;
generating a recording of said on-line interview, wherein said interviewer may make an electronic tag of said recording for later reference to and evaluation of said on-line interview;
providing a collaboration framework for developing a strategy for interviewing a selected candidate;
evaluating, by one or more evaluators, said on-line interview to provide an evaluation of said candidate.

18. The method according to claim 19, wherein said virtual interview room comprises:
an interviewer side;
a candidate side;
a question section viewable on the interviewer side; and
a virtual white board viewable on the interviewer side and the candidate side.

19. The method according to claim 19, wherein the evaluating step comprises:
sending to said one or more evaluators a link to the recording of the on-line interview; receiving rankings of said selected candidate from said one or more evaluators;
compiling said rankings; and
making a decision based on said rankings on how to proceed with said selected candidate.

20. The method according to claim 24, wherein said on-line interview is a screening interview, and-said decision is whether to invite said candidate back for followup interviews in said virtual interview room.

21. The method according to claim 24, wherein said on-line interview is one or more followup interviews, and said decision is whether to extend an offer of employment to said candidate.

22. The method according to claim 19, wherein said reviewing step further comprises:
sending said resume or said link to said resume to one or more company persons, wherein said one or more company persons create one or more comments whether said candidate may meet the job description;
receiving back from said one or more company persons said one or more comments on whether to invite said candidate for said on-line video interview;
producing a ranking of said candidate from said one or more comments; and
making a decision to invite said candidate for a screening interview.

23. The method according to claim 19, wherein said one or more evaluators is said interviewer.

24. The method according to claim 19, wherein said collaboration framework comprises:
access to a set of general questions, wherein said set of general questions is created to guide implementation of company interviewing strategies;
access to said electronic resume of said selected candidate and all other documentation provided by said selected candidate; and access to questions or an outline of questions that will be asked of said selected candidate.

25. A computer implemented method for managing an end-to-end on-line employment recruiting process for a company, the method comprising the steps: creating said job description; pushing said job description to a source; receiving an electronic resume of a candidate or a link to said resume of said candidate from said source in response to said job description; reviewing said resume comprising:
sending said resume or said link to said resume to one or more company persons, wherein said one or more company persons create one or more comments whether said candidate may meet the job description;
receiving back from said one or more company persons said one or more comments on whether to invite said candidate for said on-line video interview; and
producing a ranking of said candidate from said one or more comments;
making a decision to invite said candidate for a screening interview; sending an electronic invitation, based on said reviewing step, to a selected candidate for an on-line video interview, wherein said electronic invitation includes a link to a candidate specific account, wherein said electronic invitation requests said selected candidate to provide candidate free/busy information, and wherein said sending step further comprises utilizing interviewer free/busy information to schedule said on-line interview with said selected candidate; providing a virtual interview room for conducting said on-line video interview between said selected candidate and an interviewer, wherein said virtual interview room comprises:
an interviewer side; a candidate side;
a question section viewable on the interviewer side; and
a virtual white board viewable on the interviewer side and the candidate side; generating a recording of said on-line interview, wherein said interviewer may make an electronic tag of said recording for later reference, wherein said electronic tag associates text of the question with a location within said recording; providing a collaboration environment, wherein a to-be-interviewer may review previous interviews in preparation for an upcoming interview, wherein said collaboration environment comprises:
access to a set of general questions, wherein said set of general questions is created to guide implementation of company interviewing strategies;
access to said electronic resume of said candidate and all other documentation provided by said candidate; and
access to questions or an outline of questions that will be asked of said candidate; sending to said one or more evaluators a link to the recording of the on-line interview; receiving rankings of said selected candidate from said one or more evaluators; compiling said rankings; and making a decision based on said rankings on how to proceed with said selected candidate.
